(19) United States
(12) Patent Application Publication
(10) Pub. No.: US 2016/0006808 A1
(43) Pub. Date: Jan. 7, 2016

(54) ELECTRONIC SYSTEM WITH MEMORY NETWORK MECHANISM AND METHOD OF OPERATION THEREOF

(71) Applicant: Samsung Electronics Co., Ltd., Suwon-si (KR)

(72) Inventor: Steven Shrader, Fremont, CA (US)

(21) Appl. No.: 14/631,118

(22) Filed: Feb. 25, 2015

Related U.S. Application Data
(60) Provisional application No. 62/021,570, filed on Jul. 7, 2014.

(51) Int. Cl. H04L 29/08; G06F 3/06; H04L 12/947

(52) U.S. Cl. CPC H04L 67/1097; H04L 49/251; G06F 3/0613; G06F 3/0659; G06F 3/067

(57) ABSTRACT

An electronic system includes: a network; a memory device, coupled to the network; a host processor, coupled to the network and the memory device, providing a transaction protocol including cut through.

### CROSS-REFERENCE TO RELATED APPLICATION(S)

This application claims the benefit of U.S. Provisional Patent Application Ser. No. 62/021,570 filed Jul. 7, 2014, and the subject matter thereof is incorporated herein by reference thereto.

### TECHNICAL FIELD

An embodiment of the invention relates generally to an electronic system, and more particularly to a system for memory.

### BACKGROUND

Modern consumer and industrial electronics, especially devices such as graphical display systems, televisions, projectors, cellular phones, portable digital assistants, and combination devices, are providing increasing levels of functionality to support modern life including three-dimensional display services. Research and development in the existing technologies can take a myriad of different directions.

Memory, in particular dynamic random-access memory (DRAM), has been limited to memory modules, such as dual in-line memory modules (DIMM), in processor boards. Standard sizes of memory are placed in the processor boards of an equipment rack in a data center based on the amount of memory required for every expected condition or more.

Typically, twenty to forty percent (20%-40%) of the memory in the data center is actually used most of the time. This low utilization increases the total ownership cost (TOC) for the data center based on equipment costs as well as power to run the equipment.

Thus, a need still remains for an electronic system with memory network mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the invention provides an electronic system including: a network; a memory device, coupled to the network; a host processor, coupled to the network and the memory device, providing a transaction protocol including cut through.

An embodiment of the invention provides a method of operation of an electronic system including: providing a network; accessing a memory, coupled to the network; connecting a processor, coupled to the network and the memory, for providing a transaction protocol with cut through.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an example of a block diagram of an electronic system with network mechanism in an embodiment of the invention.

FIG. 2 is an example of a network topology of the electronic system in an embodiment of the invention.

FIG. 3 is an example of a structural view of a packet of the electronic system in an embodiment of the invention.

FIG. 4 is an example of a network topology of the electronic system in an embodiment of the invention.

FIG. 5 is an example of a network topology of the electronic system in an embodiment of the invention.

FIG. 6 is an example of a block diagram of a route sled of the electronic system 100 in an embodiment of the invention.

FIG. 7 is examples of state transitions of the electronic system in an embodiment of the invention.

FIG. 8 is examples of embodiments of the electronic system.

FIG. 9 is a flow chart of a method of operation of an electronic system in an embodiment of the invention.

### DETAILED DESCRIPTION

In an embodiment of the invention, a low latency network protocol to transport transactions can be implemented with applications other than memory access transactions. Embodiments for memory transactions are examples of embodiments of the protocol. Embodiments with memory address can also be implemented with message identification, any other referencing, or combination thereof, for this protocol to transport any traffic type.

As an example, a data center application can add hardware until all users are serviced such as with scale out methods including adding hardware until all users can be serviced. In order to lower total ownership cost (TOC) for the data center, a memory sled can be used to aggregate or combine processor memory requirements with a higher percentage of memory used.

Further to the example, this can be accomplished by allocating memory to processors as needed from a central memory sled. The amount of memory in this memory sled can be an expected aggregate of all processes on the rack. Connections between the processor sleds and the memory must be easily routable and extremely low latency with high bandwidth.

In an embodiment of the invention, high speed serial networks between processors and memory can be included to achieve low latency with a cut through protocol that uses packet information but not access to an entire packet; such as using one to two bytes upfront as well as redundant paths through a network without removal of fault detection and isolation.

Serial protocols send and receive data units called “packets”. Packets can have a fixed size, a variable size, a size indicator in the packet, or combination thereof. There can also be a protocol that indicates a start-of-packet and an end-of-packet. Verifying a successful packet transaction typically occurs after an entire packet is received. Thus, a link transfer latency of a packet can be related to the packet size.

In an embodiment of the invention, the packet protocol only needs access to one or two bytes of the packet to perform routing or to start forwarding the packet. Packet routing latency in a route node can be extremely short and a memory system for a rack can make the rack up to ninety-eight percent as fast with an average of less than fifty percent of the power for DRAM memory storage. A network in a rack architecture can provide significantly higher performance including lower latency particularly since typically networks are provided outside of a rack.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the invention.

In the following description, numerous specific details are given to provide a thorough understanding of the invention. However, it will be apparent that the invention may be practiced without these specific details. In order to avoid obscuring an embodiment of the invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the invention.

The term “module” referred to herein can include software, hardware, or a combination thereof in an embodiment of the invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

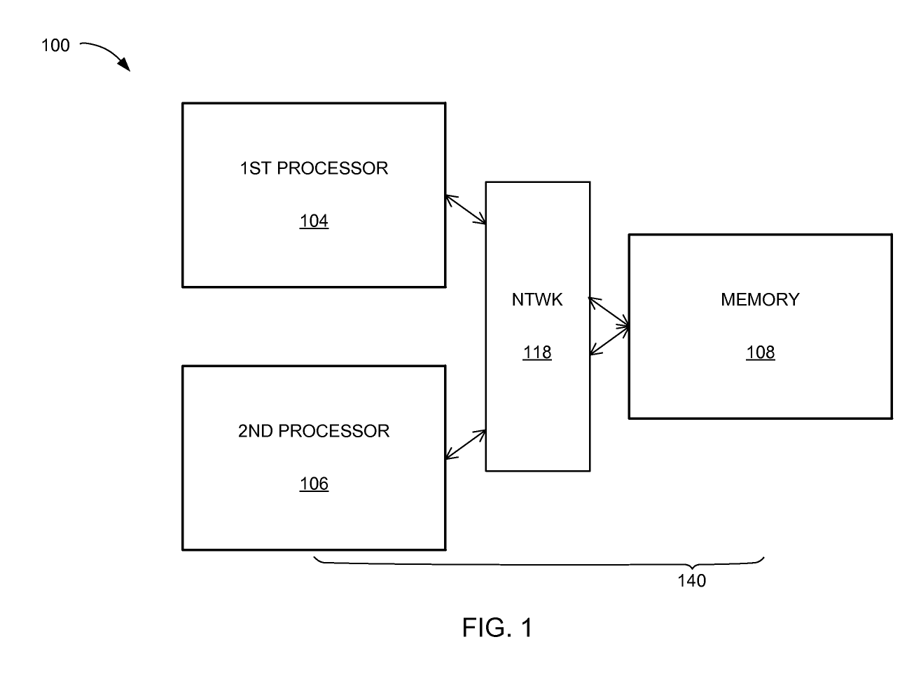

Referring now to FIG. 1, therein is shown an example of a block diagram of an electronic system 100 with network mechanism in an embodiment of the invention. The electronic system 100 can provide a dedicated memory network for one or more hosts and one or more memory systems. The electronic system 100 can move data from multiple sources to multiple destinations. The dedicated memory network can augment or replace direct attached memory. The electronic system 100 can include a rack architecture.

In an embodiment of the invention, a first host processor 104, such as a host central processing unit (CPU), a second host processor 106, such as a host central processing unit (CPU), can be connected to a memory device 108 such as a memory sled, a dual data rate (DDR) SDRAM sled, or combination thereof. The first host processor 104, the second host processor 106, the memory device 108, or combination thereof, can be connected to a network 118. The network 118, which can be included in a rack architecture, can provide access to the memory device 108 for the first host processor 104, the second host processor 106, or combination thereof.

In an embodiment of the invention, the network 118 can provide significantly lower latency for access to the memory device 108. For example, the network 118 can provide latency of less than one-hundred milliseconds (100 ms) or less than 250 nanoseconds (250 ns), which is significantly lower than processor memory systems with latency of approximately one-hundred milliseconds (100 ms).

In an embodiment of the invention, the memory device 108 is disaggregated from the first host processor 104, the second host processor 106, other processors, other devices, or combination thereof. For example, an open rack architecture can disaggregate dynamic random access memory (DRAM) from a central processing unit (CPU) with the DRAM on a different sled than the CPU, such as in a rack architecture for large-scale or hyper-scale processing.

In an embodiment of the invention, rack mounts can accommodate sleds with various lengths and heights, such as in a server rack. The sleds can include the first host processor 104, the second host processor 106, the memory device 108, or combination thereof. For example, about forty-three (43) seventeen inch (17-inch) sleds can be included in a rack connected with the network 118 such as Peripheral Component Interconnect Express (PCIe), Serial Advanced Technology Attachment (SATA), other interconnect attach technologies, or combination thereof.

The first host processor 104, the second host processor 106, the memory device 108, the network 118, or combination thereof, can provide a transaction protocol 140 such as a low latency protocol, a cut through protocol, or combination thereof. The transaction protocol 140 can be applied to interactions including requests, commands, data, memory requests, memory commands, memory data, or combination thereof, with the first host processor 104, the second host processor 106, the memory device 108, the network 118, or combination thereof.

For example, a memory transaction of the transaction protocol 140 can include cut through or a cut through process, which requires a limited number of bytes, such as only one to two bytes, for routing a memory request, memory commands, memory data, or combination thereof. The transaction protocol 140 can provide minimal or low latency transfer of the memory request, the memory commands, the memory data, or combination thereof, for the memory network including the first host processor 104, the second host processor 106, the memory device 108, the network 118, or combination thereof, of the electronic system 100.

The electronic system 100 with the transaction protocol 140 can provide extremely low transaction transmission latency with multiple routing hops. The extremely low transaction transmission latency with the multiple routing hops can be implemented in a rack with routing independent of memory address.

Rack implementations with multiple hops independent of memory address can result in a rack that is up to ninety-eight percent as fast, with a small percentage of performance lost with a serial link down, and has an average of less than fifty percent of the power, for rack implementations without multiple hops independent of memory address, such as for DRAM memory storage. The rack implementations with multiple hops independent of memory address can also provide expansion to multiple layers of memory, sleds, or combination thereof.

For example, the electronic system 100 in a single rack can include forty-eight of the memory devices 108, such as memory sleds, each with thirty-two leaf cells for a rack providing one thousand thirty-six destinations. Further, this number of sources and nodes would provide approximately eight thousand total addresses (about thirteen bits).

In an embodiment, the network 118 can include a high speed interface physical device (PHY), communication methods such as 10G, 25G, PCIe, GEN3, new routing protocol logic, new routing protocol software, or combination thereof. For routing a memory request, memory commands, memory data, or combination thereof, the network 118 including the communication methods or protocol can preferably provide low transfer latency and access to at least a first one or two bytes of a packet.

In an embodiment, the electronic system 100 can include a rack with only memory sleds. For example, a rack can include thirty-two (32) of the memory device 108 or memory sleds with eight terabytes (8 TB) per memory device 108 or memory sled for two hundred fifty-six terabytes (256 TB) per rack. Forty-eight (48) bit physical addresses can be required to address or access the 256 TB.

For example, the rack can be organized with a leaf cell address concept including forty-eight (48) leaf cells per the memory device 108 or memory sled with thirty-two (32) of the memory device 108 or memory sled, providing one thousand five hundred thirty-six (1536) leaf cells requiring thirteen (13) address bits. The 13 address bits can be part of the total address resulting in thirty-seven (37) remaining bits for a DRAM controller address.

In an alternate example, the 13 address bits would be independent of the bits for a DRAM controller address. Thus, all 48 bits would be available for the DRAM controller address providing additional flexibility for each leaf node to have all sections of the total address rather than a fixed section of a portion of the total address.

For illustrative purposes, the electronic system 100 is shown with a memory transaction of the transaction protocol 140, although it is understood that any transaction or traffic type may be used. For example, message identification, any other referencing, or combination thereof may be implemented with the electronic system 100.

It has been discovered that the electronic system 100 with disclosed network mechanisms can provide extremely low transaction transmission latency. The extremely low transaction transmission latency can be implemented with multiple routing hops and can make a rack up to ninety-eight percent as fast with an average of less than fifty percent of the power, such as for DRAM memory storage.

It has also been discovered that electronic system 100 with the network 118 can be in a rack architecture. The network 118 in a rack architecture provides significantly higher performance including lower latency particularly since typically networks are provided outside of a rack.

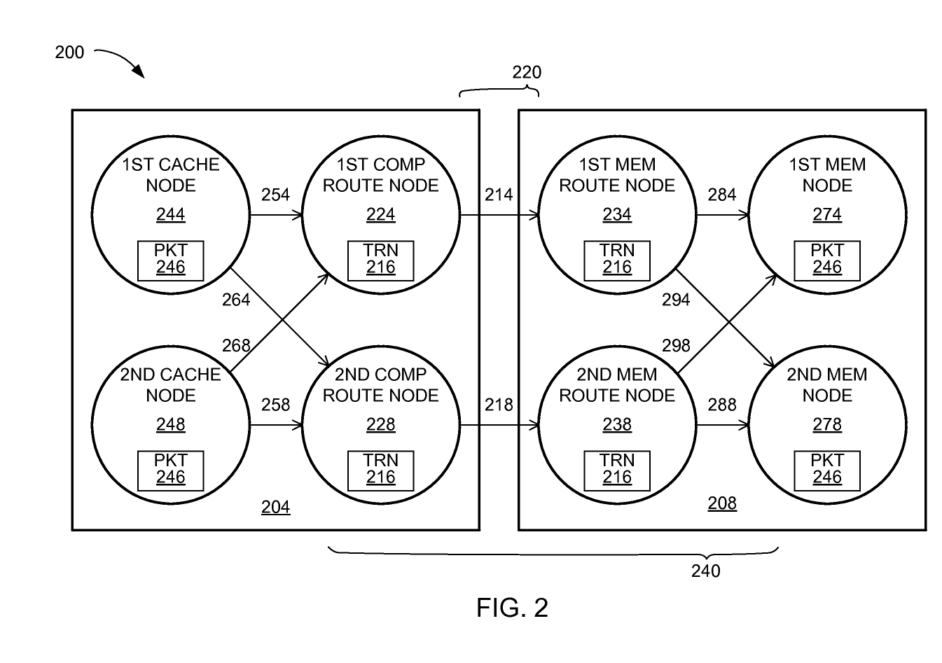

Referring now to FIG. 2, therein is shown an example of a network topology 200 of the electronic system 100 in an embodiment of the invention. The network topology 200 can include paths or pathways for routing memory packets.

In an embodiment of the invention, a compute sled 204, including the first host processor 104 of FIG. 1, the second host processor 106 of FIG. 1, or combination thereof, can route memory packets to a memory sled 208 including the memory device 108 of FIG. 1. A first sled path 214, such as a communication component, can include memory transactions 216 such as memory read transactions including a memory read request, a data transfer, a memory write request, or combination thereof, for the compute sled 204 and the memory sled 208.

In a manner similar to the first sled path 214, a second sled path 218, such as another communication component, can also include the memory transactions 216 for the compute sled 204 and the memory sled 208. For example, a network 220, such as the network 118, including the first sled path 214 and the second sled path 218 can provide redundant or different paths or access for the memory transactions 216.

The memory transactions 216 can include parameters of a data transfer network protocol including forward error correction, on on-the-fly error detection, flow of control, end-to-end error correction, lost and mis-directed packet detection and recovery, individual link bit error rate (BER) calculation, disable, or combination thereof. The memory transactions 216 with data transfer network protocol parameters can be provided with low latency, preferably very or extremely low latency.

In another embodiment of the invention, the first sled path 214 or the second sled path 218 can operate without the other of the sled paths with increased latency, reduced bandwidth, or combination thereof. For illustrative purposes the first sled path 214 and the second sled path 218 are shown although it is understood that any number of the first sled path 214, the second sled path 218, or combination thereof, may be used to increase bandwidth and reduce latency.

A first compute route node 224, a second compute route node 228, or combination thereof, can provide, send, receive, or combination thereof, the memory transactions 216 for the compute sled 204 with, over, or through, the first sled path 214, the second sled path 218, or combination thereof. The first compute route node 224, the second compute route node 228, or combination thereof, can provide or send the memory transactions 216 to the memory sled 208, receive the memory transactions 216 from the memory sled 208, or combination thereof.

Similarly, a first memory route node 234, a second memory route node 238, or combination thereof, can provide, send, or receive, or combination thereof, the memory transactions 216 for the memory sled 208 with, over, or through, the first sled path 214, the second sled path 218, or combination thereof. The first memory route node 234, the second memory route node 238, or combination thereof, can provide or send the memory transactions to the compute sled 204, receive the memory transactions 216 from the compute sled 204, or combination thereof, in a memory network of the electronic system 100.

The first compute route node 224, the second compute route node 228, the first memory route node 234, the second memory route node 238, or combination thereof, can provide a low latency protocol 240 such as the transaction protocol 140 of FIG. 1. The low latency protocol 240 can provides minimal or low latency for the memory transactions 216 including the packets 246 for the memory network including the network 220 of the electronic system 100 including the compute sled 204, the memory sled 208, or combination thereof.

A first cache node 244, a second cache node 248, or combination thereof, can provide memory packets 246 with a first cache route path 254, a second cache route path 258, or combination thereof. Further, The first cache node 244, the second cache node 248, or combination thereof, can provide the memory packets 246 with a third cache route path 264, a fourth cache route path 268, or combination thereof.

Each compute cache node of the compute sled 204, such as the first cache node 244, the second cache node 248, or combination thereof, can access at least two paths, such as the first cache route path 254, the second cache route path 258, or combination thereof, for routing the memory packets 246. The memory transactions 216 can be source-based and destination-based such as a memory read request and a data transfer. The memory read request and the data transfer can be distinct or separate and can be transmitted with distinct, separate, or different paths of the network 220.

One of the links, implemented with the first sled path 214 or the second sled path 218, can include all the memory transactions 216 based on a broken link. Two links with one broken link results in increased latency and reduced bandwidth. In an embodiment, more than two links implemented with the first sled path 214, the second sled path 218, or combination thereof, can provide multiple redundant links for increased bandwidth and reduced latency.

A number of links can be independent from a quantity of cache nodes, memory nodes, or combination thereof. The number of links can be based on a quantity of route nodes such as the first compute route node 224, the second compute route node 228, or combination thereof. Similarly, a number of links can be based on a quantity of route nodes such as the first memory route node 234, the second memory route node 238, or combination thereof.

The first cache node 244 can be a portion of or included in the compute sled 204 with the first host processor 104. Similarly the second cache node 248 can be a portion of or included in the compute sled 204 with the second host processor 106. The first compute route node 224, the second compute route node 228, or combination thereof, can be a portion of or included in the compute sled 204, the network 220, the network 118 of FIG. 1, or combination thereof.

For illustrative purposes, the first cache route path 254, the second cache route path 258, the third cache route path 264, and the fourth cache route path 268, are shown, although it is understood that any number of cache route paths may be used based on a quantity of cache nodes, a quantity of route nodes, or combination thereof. The first cache node 244, the second cache node 248, or combination thereof, can provide the memory packets 246 to the first compute route node 224, the second compute route node 228, or combination thereof.

The first memory route node 234, the second memory route node 238, or combination thereof, can provide or send the memory packets 246 to a first memory node 274, a second memory node 278, or combination thereof. Similarly, the first memory route node 234, the second memory route node 238, or combination thereof, can receive the memory packets 246 from a first memory node 274, a second memory node 278, or combination thereof.

The first memory route node 234, the second memory route node 238, the first memory node 274, the second memory node 278 or combination thereof, can provide the memory packets 246 with a first route memory path 284, a second route memory path 288, a third route memory path 294, a fourth route memory path 298, or combination thereof. For illustrative purposes, the first route memory path 284, the second route memory path 288, the third route memory path 294, and the fourth route memory path 298, are shown although it is understood that any number of route memory paths may be used.

The first memory node 274, the second memory node 278, or combination thereof can be a portion of or included in the memory device 108. The first memory route node 234, the second memory route node 238, or combination thereof can be a portion of or included in the memory device 108, the network 118, or combination thereof. The first memory route node 234, the second memory route node 238, or combination thereof can provide the packets 246 for access by the compute sled 204 on the network 220.

For illustrative purposes, a number of the first sled path 214, the second sled path 218, combination thereof, equal a number of the first cache node 244, the second cache node 248, combination thereof, although it is understood that any number of the first sled path 214, the second sled path 218, or combination thereof, may be used. The number of the first sled path 214, the second sled path 218, or combination thereof, are independent of the number of the first cache node 244, the second cache node 248, or combination thereof.

It has been discovered that the electronic system 100 provides the memory transactions 216 with low latency. The memory transactions 216 can include memory read requests, data transfers, memory write requests, data transfer network protocol parameters, such as forward error correction, on on-the-fly error detection, flow of control, end-to-end error correction, lost and miss directed packet detection and recovery, individual link bit error rate (BER) calculation, disable, or combination thereof.

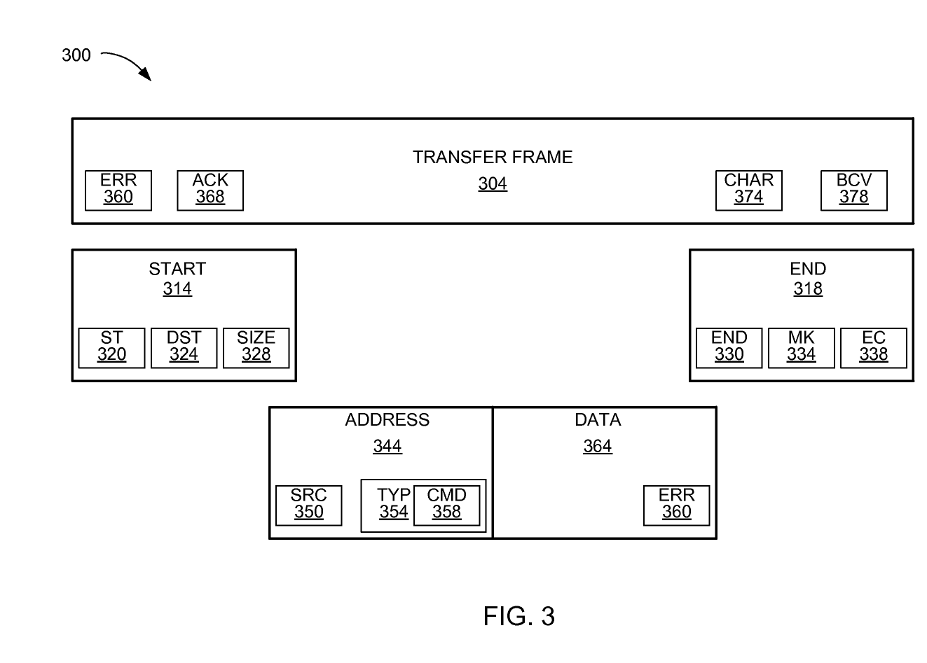

Referring now to FIG. 3, therein is shown an example of a structural view of a packet 300 of the electronic system 100 in an embodiment of the invention. In a multi-node network, such as the electronic system 100 with the memory network mechanism of FIG. 1, the example of the network topology of the electronic system 200 of FIG. 2, or combination thereof, the electronic system 100 can provide low latency by receiving a small amount of data indicating a next node for immediately forwarding a packet. In an embodiment of the invention, one or two packet bytes can indicate the next node to start forwarding. Multiple hops or node destinations can increase a time delay by a small amount of time per node. For illustrative purposes, the packet 300 is shown with several components, although it is understood that other components may be included, there may be any number of the components, or combination thereof.

A hardware physical layer (PHY), such as may be included with the first compute route node 224 of FIG. 2, the second compute route node 228 of FIG. 2, the first memory route node 234 of FIG. 2, the second memory route node 238 of FIG. 2, or combination thereof, can be configured to perform data transfer at a byte-level for access to each byte of packets such as the packet 300, the memory packet 246 of FIG. 2, or combination thereof. The electronic system 100 can access one or two bytes of the packets to perform routing providing extremely short packet routing latency.

For example, each hop or node can add five to ten nanoseconds (5-10 ns) per hop or node. A read transaction based on a same number of hops or nodes in both directions can add ten to twenty nanoseconds (10-20 ns). This additional time or delay can be independent of packet size and does not include error correction, such as with error correction code (ECC), since error correction can be provided at a destination.

For example, routing error information can be dynamically added to packets 300 for failure analysis (FA). Errors, such as errors addressed with ECC, cyclic redundancy check (CRC), or combination thereof, can provide information about a link including performance, statistics, re-routing to another link, or combination thereof.

In an embodiment of the invention, the packet 300 can include a transfer frame 304, a start section 314, an end section 318, or combination thereof. The start section 314 can include a start-character 320, such as a packet start-character, a destination 324, a size 328, or combination thereof. The start section 314 can provide a start for the transaction protocol 140 of FIG. 1, the memory transactions 216 of FIG. 2, or combination thereof.

The end section 318 can include an end-character 330, such as a packet end-character, the destination 324, the size 328, a mark 334, an error correction character 338 such as for error correction code (ECC), or combination thereof. The end section 318 can provide an end for the transaction protocol 140, the memory transactions 216 of FIG. 2, other transactions, or combination thereof.

The packet 300 can also include an address section 344 including a source address 350, a type (T) 354, such as a packet type, or combination thereof. The type 354 can include a command sequence tag 358. The address section 344, including the source address 350, the type 354, the command sequence tags 358, or combination thereof, can provide a global memory address concept in a rack architecture, particularly with multiple memory nodes such as the first memory node 274, the second memory node 278, or combination thereof.

For example, the type 354 such as a packet type, memory transaction type, or combination thereof, can typically be a read/write flag. The type 354 can optionally be a first-word byte enable, a last-word byte enable, encoding of the first-word byte enable, encoding of the last-word byte enable, command fragmentation status indicating fragmented commands, or combination thereof.

Fragmenting large transactions, such as the transaction protocol 140, the memory transactions 216, other transactions, or combination thereof, can provide fairness, balance, or resource sharing with other transactions. Fragmenting large transactions with redundant links can lower overall latency by simultaneously transporting different transaction fragments over more than one link with some overhead for reassembly, extra redundancy of error correction, or combination thereof.

In an embodiment, memory defects such as DRAM memory skipping can be avoided. Avoiding memory defects can provide error recovery, failure isolation, or combination thereof. For example, redundant resources, such as redundant memory, can avoid a defective or bad link, a defective or bad memory including DRAM, or combination thereof.

The error correction character 338 can provide detection of errors 360 from the start section 314. The mark 334, such as a mark entry, can include identification for a node, a link, a path, the error 360, or combination thereof, for allowing a bit error rate (BER) calculation for a specific of the node, the link, the path, or combination thereof, such as the nodes, links, and paths of FIG. 2. The error 360, such as a detected error, can be a portion of the packet 300, a portion of data 364, a transmitted portion of the packet 300, a transmitted portion of the data 364 or combination thereof.

The type 354 can include the command sequence tag 358, such as identifiers that a command is segmented in multiple commands. The command sequence tags 358 can indicate that the multiple commands require re-assembly and ordering for completing a transaction such as the memory transactions 216 of FIG. 2. Optionally, the packet 300 can include the data 364. The data 364 can be provided on a return or response for a read request and on a send or response for a write request.

A cut through protocol such as the transaction protocol 140, the low latency protocol 240 of FIG. 2, or combination thereof, provides minimal, reduced, or low latency for a memory network, of the electronic system 100 including the first host processor 104, the second host processor 106, the memory device 108 of FIG. 1, the network 118, or combination thereof.

The cut through protocol can include cut through or a cut through process preferably requiring only a limited number of bytes, such as one to two bytes, for routing a memory request, memory commands, memory data, or combination thereof. The cut through protocol can provide minimal or low latency for the memory network including the first host processor 104, the second host processor 106, the memory device 108, the network 118, or combination thereof, of the electronic system 100.

The cut through protocol can include an acknowledge signal (ACK) 368 based on sending one or more of the packets 300. The ACK 368 can trigger the cut through protocol to send a next one or more of the packets 300. The ACK 368 can be sent or transmitted with a node, a link, a path, utilized as a return link or node.

In an embodiment of the invention, the cut through protocol with the packet 300 can provide the ACK 368 based on the destination 324 and the size 328. The ACK 368 can be provided without receiving the entirety of the packet 300.

For example, a link protocol can send a number “X” of the packets 300 and wait for the ACK 368 before sending more of the packets 300. The ACK 368 can be sent between the packets 300 on a node, a link, or a path utilized as a return node. The ACK 368 can be required for flow of control and can be based on the destination 324 and the size 328. Based on the destination 324 and size 328, the cut through protocol can provide a switch set to go to a next link, which can result in transmitting the ACK 368 without receipt of an entirety of the packet 300.

Further, the ACK 368 can include characters 374, such as a pair of characters, which differ from the start section 314 or the end section 318. The ACK 368 can also include a buffer credit value 378 between a pair of the characters 374. The buffer credit value 378 can start at a number “X”, such as the number of the packets 300 sent and decrement to zero (0). Based on an unrecognized of the packets 300, such as due to a link issue, a receiver will not acknowledge a packet and thus the buffer credit value 378 will not change. Based on the buffer credit value 378 not changing, data transfer can continue with a lost packet of the packets 300. The memory transaction 216 of FIG. 2 can timeout for recovery.

In an embodiment, a link can shut down based on a mismatch of the size 328 with the start section 314 and the end section 318. Further, a return link can be turned off, which can result in an inbound link to be turned off. Thus, redundant links can provide traffic routes, paths, communication, or combination thereof.

In an embodiment, each node can have an identification, such as a destination, a source, unique destination range such as by an address bit, or combination thereof. Transactions, such as the transaction protocol 140, the memory transactions 216, other transactions, or combination thereof, can be processed based on each node having an assigned identification (ID) for receiving configuration commands, such as command sequence tags 358, for setting up routing. An address, such as the address section 344, can be provided to a node by a message sent to a link attached to the node indicating the address. The address can include a start such as start section 314, a value of the address such as the address section 344, and an end such as the end section 318. The node can be addressed with the value of the address.

Further, the start and the end without a value of the address can result in a query to the node for an address of the node. The node can respond to the query with the address of the node and selectively set the address of the node. Setting the address of the node can provide for configuration of the node for routing transactions on connected links. Routing through a network, such as the network 118 of FIG. 1, the network 220 of FIG. 2, or other networks, can include a network table.

For example, the network table can include instructions or commands for routing to one of a following list of output links based on a packet received from a specified link. The routing table can enable a node to begin memory packet routing. The memory packet routing can include configuring leaf nodes, destination nodes, or combination thereof.

In a manner similar to the configuration of routing, node functions can be configured. Configuration information can be set by an address such as the address section 344, other addresses, or combination thereof. The configuration information or data can be read based on the address to determine contents of the address or status stored at the address by a node or leaf cell. Configuration traffic can be performed by an in store-and-forward process for lower complexity instead of a low-latency, pipelined traffic such as memory transactions. An acknowledgement, such as the ACK 368, can be provided to a source based on a write transaction with a write data cyclic redundancy check (CRC) to verify that data was correctly written.

Further, a destination, such as a destination leaf cell, can return a negative-acknowledgement (NACK) to a source, such as from a leaf cell, indicating a transaction was dropped such as to reduce a transaction latency re-start at the source. The destination can receive a transaction that an error correction code (ECC) cannot correct, preventing verification of the source or destination and resulting in a dropped packet. The source can be required to wait for the transaction to timeout before re-launching the transaction. Verifying the source can result in a NACK to require the sender to re-send the packet without waiting for the timeout.

Alternatively, a destination, such as a destination leaf cell, can receive a corrupted transaction that can be corrected with the ECC, and determine whether a destination address error resulted in arrival at a wrong leaf cell. The wrong leaf cell can send the packet to a correct destination.

Any destination can setup, test, or combination thereof, the network, such as the network 118, the network 220, or combination thereof. Any destination can also test configured memory such as the memory device 108, the memory sled 208 of FIG. 2, or combination thereof. Parallel network memory test can be run to determine pass or fail based on a memory, a dual in-line memory module (DIMM), or combination thereof. The network memory test can determine network integrity based on executing multiple transactions for all interfaces including loop back to initiating interfaces that started a test.

For illustrative purposes, the example of the structural view of the packet 300 is shown with several components of the transfer packet 304 although it is understood that other components may be included.

Further for illustrative purposes, the example of the structural view of the packet 300 is shown with one of the transfer packet 304 although it is understood that there may be any number of the transfer packet 304.

It has been discovered that the electronic system 100 with the packet 300 including the start section 314 provides the transaction protocol 140 with cut through for minimal or low latency transfer of the memory request, the memory commands, the memory data, or combination thereof. The transaction protocol 140 with cut through requires a limited number of bytes, such as only one or two bytes, for routing a memory request, memory commands, memory data, or combination thereof.

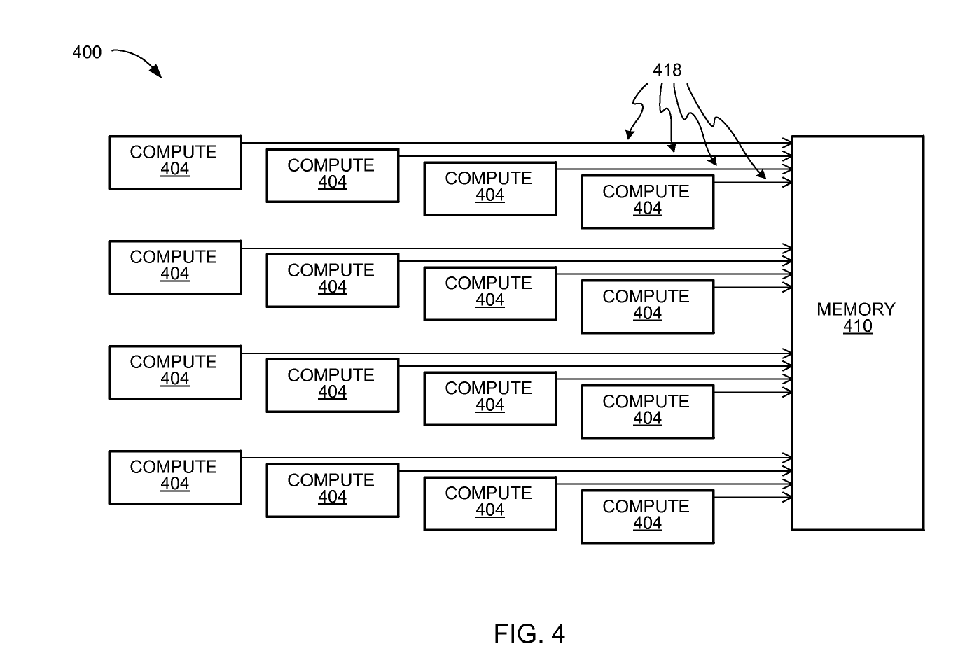

Referring now to FIG. 4, therein is shown an example of a network topology 400 of the electronic system 100 in an embodiment of the invention. The network topology 400 can include a number of compute nodes for interaction with each memory sled. For example, a ratio of compute nodes to memory sleds can be about 16:1 based on each compute node directly connecting to sixteen (16) DRAM controllers provided on a memory sled of the network topology 400.

In an embodiment, paths for data such as memory transactions including routing memory packets can be balanced for input and output based on a compute node accessing memory that no other compute node is accessing, such as on a memory bank level, and no paths constrain compute or memory bandwidth. For example, given a compute node provides four gigabytes per second (4 GB/s) to a memory sled, the path to the memory sled supports at least 4 GB/s in one link or redundant link. One or more redundant links for each path can provide maximum performance with a failure of a link.

In an embodiment, a path can require multiple links for compute and memory bandwidth. At least one additional link can preferably be provided to ensure full performance. For example, the path can require four links, such as serial links, to provide 4 GB/s. The pathway can include five links, including a redundant link, providing full performance with a failure of one of the links.

The network topology 400 can include compute devices 404 such as host central processing units (CPUs). The compute devices 404 can access a memory device 408 such as a memory sled, a DDR SDRAM sled, or combination thereof. Paths 418 can provide links (not shown) for input, output, redundancy, or combination thereof. All of the compute devices 404 can access all of the memory device 408 eliminating the need for a route device such as a route sled.

For illustrative purposes, the paths 418 individually connect the compute devices 404 to the memory device 408 although it is understood that the compute devices 404 and the memory device 408 can be connected to each other as well. Some or all of the compute devices 404 can communicate with some or all of other of the compute devices 404.

Further for illustrative purposes, the paths 418 are shown with directional arrows from the compute devices 404 to the memory device 408 although it is understood that the paths 418 can be bi-directional to provide input and output access, transfer, communication, or combination thereof.

It has been discovered that the electronic system 100 with the example of the network topography 400 provides memory transactions with full performance or maximum performance. The memory device 408 provides access for multiple compute devices 404 simultaneously.

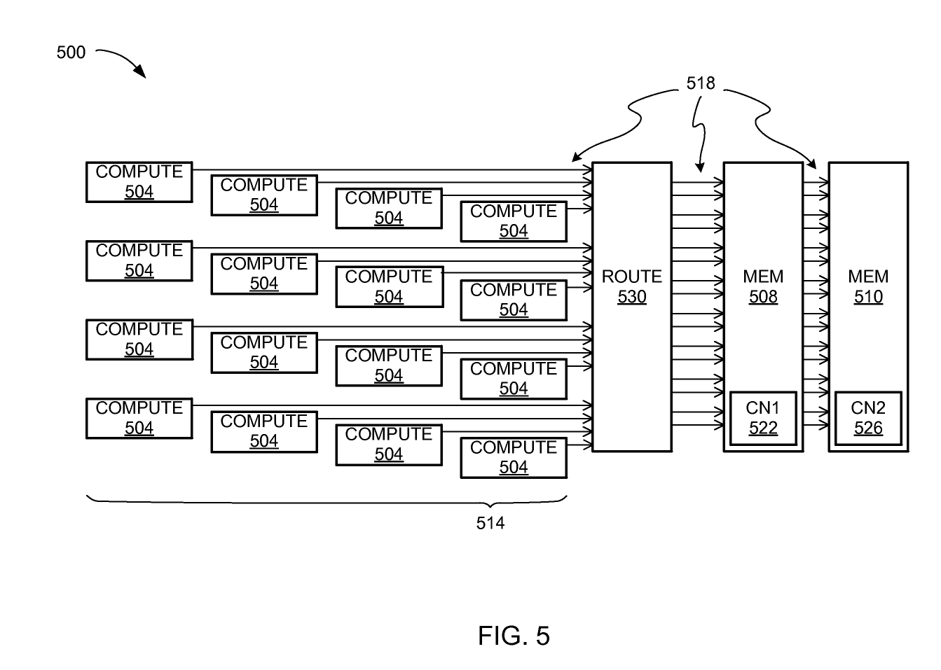

Referring now to FIG. 5, therein is shown an example of a network topology 500 of the electronic system 100 in an embodiment of the invention. The network topology 500 can include a number of compute nodes for each memory sled. For example, a ratio of compute nodes to memory sleds can be about 16:1 based on each compute node directly connecting to sixteen (16) DRAM controllers provided on a memory sled of the network topology 500.

In an embodiment, multiple compute devices 504, such as compute nodes, can connect to more than one memory device or memory sleds such as a first memory device 508, a second memory device 510, or combination thereof. The compute devices 504 can be included in a compute assembly 514 such as a compute sled. Paths 518 can provide links for input, output, redundancy, or combination thereof. For example, the compute devices 504 can communicate with first controllers 522 of the first memory device 508, and second controllers 526 of the second memory 510.

In an embodiment, a route device 530, such as a route sled, can provide access to the compute assembly 514 including the compute devices 504 with multiple memory devices for memory capacity. For example, sixteen of the compute devices 504 can access twice the memory including the first memory device 508, such as a memory sled, and the second memory device 510, such as a memory sled, with a twenty to fifty nanosecond delay based on configuration.

In an embodiment, the route device 530 can connect and manage communication through the paths 518 with the first memory device 508, the second memory device 510, or combination thereof. For example, the route device 530 can manage communication with sixteen (16) of the compute devices 504, sixteen (16) of the first controllers 522, such as 16 DDR controllers, and sixteen (16) of the second controllers 526, such as 16 DDR controllers.

In an embodiment, the paths 518, such as nodes, can provide bandwidth for access or communication with both the first memory device 508 and the second memory device 510. For example, the paths 518 can provide twice the bandwidth required for communication with one memory such as the first memory device 508, the second memory device 510, or combination thereof.

In an embodiment, the compute devices 504, including the first memory device 508, the second memory device 510, or combination thereof, can be connected in a rack. For example, six (6) of the compute devices 504 can communicate with sixteen (16) of the first memory device 508, the second memory device 510, or combination thereof. Pathways, such as the paths 518, can be provided by the equation 6*x+16*(42−x), resulting in six hundred sixty-two (662) pathways. Thus, the rack, such as a forty-two rack unit (42U), can include the compute assembly 514 and forty-one (41) memory sleds including the first memory device 508, the second memory device 510, or combination thereof, with sixteen pathways, such as the paths 518, in use.

In an embodiment, six (6) of the paths 518, such as balanced pathways, can be in use between the compute devices 504, the first memory device 508, the second memory device 510, or combination thereof. For example, thirty-one (31) of the compute devices 504 and ten (10) memory sleds, such as the first memory device 508, the second memory device 510, or combination thereof, can be included in a 42U rack.

Further, the paths 518 can connect to approximately one hundred ninety-two (192) of the compute devices 504 and approximately one hundred seventy-six (176) of the memory sleds. This would result in a compute to memory ratio of approximately three to one (3:1) and approximately three hundred sixty-two of the paths 518 for a balanced system in one rack including top of rack (TOR), middle of rack (MOR), or combination thereof.

For illustrative purposes the example of the network topography 500 is shown with the route device 530 as a distinct device although it is understood that the route device 530 can be implemented differently, for example as a portion of another device.

It has been discovered that the electronic system 100 with the example of the network topography 500 provides memory transactions with full performance or maximum performance. The first memory device 508, the second memory device 510, or combination thereof, provides access for multiple compute devices 504 simultaneously.

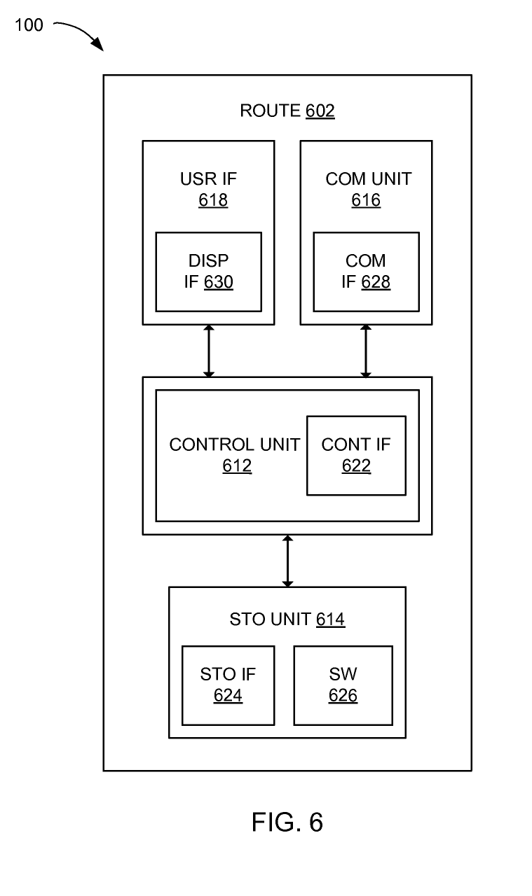

Referring now to FIG. 6, therein is shown an example of a block diagram of a route sled 602 of the electronic system 100 in an embodiment of the invention. The route sled 602, such as a client device, a server, an interface device, or combination thereof, can provide access, connection, communication, or combination thereof, for the electronic system 100, in a manner similar to the route sled 530.

The route sled 602 can include a control unit 612, a storage unit 614, a communication unit 616, and a user interface 618. The control unit 612 can include a control interface 622. The control unit 612 can execute software 626 of the electronic system 100.

The control unit 612 can be implemented in a number of different manners. For example, the control unit 612 can be a processor, an application specific integrated circuit (ASIC) an embedded processor, a microprocessor, a hardware control logic, a hardware finite state machine (FSM), a digital signal processor (DSP), or combination thereof. The control interface 622 can be used for communication between the control unit 612 and other functional units. The control interface 622 can also be used for communication that is external to the route sled 602.

The control interface 622 can receive information from the other functional units or from external sources, or can transmit information to the other functional units or to external destinations. The external sources and the external destinations refer to sources and destinations external to the route sled 602.

The control interface 622 can be implemented in different ways and can include different implementations depending on which functional units or external units are being interfaced with the control interface 622. For example, the control interface 622 can be implemented with a pressure sensor, an inertial sensor, a microelectromechanical system (MEMS), optical circuitry, waveguides, wireless circuitry, wireline circuitry, or a combination thereof.

The storage unit 614 can store the software 626. The storage unit 614 can also store relevant information, such as data, images, programs, sound files, or a combination thereof. The storage unit 614 can be sized to provide additional storage capacity.

The storage unit 614 can be volatile memory, nonvolatile memory, internal memory, an external memory, cache memory, or a combination thereof. For example, the storage unit 614 can be a nonvolatile storage such as non-volatile random access memory (NVRAM), Flash memory, disk storage, or a volatile storage such as static random access memory (SRAM), dynamic random access memory (DRAM), any memory technology, or combination thereof.

The storage unit 614 can include a storage interface 624. The storage interface 624 can provide access, connection, communication, or combination thereof, with other functional units internal to the route sled 602. The storage interface 624 can also be used for communication that is external to the route sled 602.

The storage interface 624 can receive information from the other functional units or from external sources, or can transmit information to the other functional units or to external destinations. The external sources and the external destinations refer to sources and destinations external to the route sled 602.

The storage interface 624 can include different implementations depending on which functional units or external units are being interfaced with the storage unit 614. The storage interface 624 can be implemented with technologies and techniques similar to the implementation of the control interface 622.

For illustrative purposes, the storage unit 614 is shown as a single element, although it is understood that the storage unit 614 can be a distribution of storage elements. Also for illustrative purposes, the electronic system 100 is shown with the storage unit 614 as a single hierarchy storage system, although it is understood that the electronic system 100 can have the storage unit 614 in a different configuration. For example, the storage unit 614 can be formed with different storage technologies forming a memory hierarchal system including different levels of caching, main memory, rotating media, or off-line storage.

The communication unit 616 can enable external communication to and from the route sled 602. For example, the communication unit 616 can permit the route sled 602 to communicate with a second device (not shown), an attachment, such as a peripheral device, a communication path (not shown), or combination thereof.

The communication unit 616 can also function as a communication hub allowing the route sled 602 to function as part of the communication path and not limited to be an end point or terminal unit of the communication path. The communication unit 616 can include active and passive components, such as microelectronics or an antenna, for interaction with the communication path.

The communication unit 616 can include a communication interface 628. The communication interface 628 can be used for communication between the communication unit 616 and other functional units in the route sled 602. The communication interface 628 can receive information from the other functional units or can transmit information to the other functional units.

The communication interface 628 can include different implementations depending on which functional units are being interfaced with the communication unit 616. The communication interface 628 can be implemented with technologies and techniques similar to the implementation of the control interface 622, the storage interface 624, or combination thereof.

The user interface 618 can allow a user (not shown) to interface and interact with the route sled 602. The user interface 618 can include an input device, an output device, or combination thereof. Examples of the input device of the user interface 618 can include a keypad, a touchpad, soft-keys, a keyboard, a microphone, an infrared sensor for receiving remote signals, other input devices, or any combination thereof to provide data and communication inputs.

The user interface 618 can include a display interface 630. The display interface 630 can include a display, a projector, a video screen, a speaker, or any combination thereof.

The control unit 612 can operate the user interface 618 to display information generated by the electronic system 100. The control unit 612 can also execute the software 626 for the other functions of the electronic system 100. The control unit 612 can further execute the software 626 for interaction with the communication path via the communication unit 616.

The route sled 602 can also be optimized for implementing an embodiment of the electronic system 100 in a single or multiple device embodiment. The route sled 602 can provide additional or higher performance processing power.

For illustrative purposes, the route sled 602 is shown partitioned with the user interface 618, the storage unit 614, the control unit 612, and the communication unit 616, although it is understood that the route sled 602 can have any different partitioning. For example, the software 626 can be partitioned differently such that at least some functions can be in the control unit 612 and the communication unit 616. Also, the route sled 602 can include other functional units not shown here for clarity.

The functional units in the route sled 602 can work individually and independently of the other functional units. For illustrative purposes, the electronic system 100 is described by operation of the route sled 602 although it is understood that the route sled 602 can operate any of the processes and functions of the electronic system 100.

Processes in this application can be hardware implementation, hardware circuitry, or hardware accelerators in the control unit 612. The processes can also be implemented within the route sled 602 but outside the control unit 612.

Processes in this application can be part of the software 626. These processes can also be stored in the storage unit 614. The control unit 612 can execute these processes for operating the electronic system 100.

The modules described in this application can be implemented as instructions stored on a non-transitory computer readable medium to be executed by a control unit 612. The non-transitory computer medium can include the storage unit 614. The non-transitory computer readable medium can include non-volatile memory, such as a hard disk drive (HDD), non-volatile random access memory (NVRAM), solid-state storage device (SSD), compact disk (CD), digital video disk (DVD), universal serial bus (USB) flash memory devices, Blu-ray Disc™, any other computer readable media, or combination thereof. The non-transitory computer readable medium can be integrated as a part of the electronic system 100 or installed as a removable portion of the electronic system 100.

The modules described in this application can also be part of the software 626. These modules can also be stored in the storage unit 614. The control unit 612 can execute these modules for operating the electronic system 100.

The modules described in this application can be hardware implementation, hardware circuitry, or hardware accelerators in the control unit 612. The modules can also be hardware implementations, hardware circuitry, or hardware accelerators within the route sled 602 but outside of the first control unit 612.

For illustrative purposes the electronic system 100 with route sled 602 is shown with one each of the control unit 612, the storage unit 614, the communication unit 616, and the user interface 618, although it is understood that any number may be implemented.

It has been discovered that the electronic system 100 with the route sled 602 provides access, connection, communication, or combination thereof, for the first host processor 104 of FIG. 1, the second host processor 106 of FIG. 1, the memory 108 of FIG. 1, the network 118 of FIG. 1, the compute sled 204 of FIG. 2, the memory sled 208 of FIG. 2, or combination thereof. Functions of the route sled 602 can be implemented in other devices of the electronic system 100 or as a separate device of the electronic system 100, for the transaction protocol 140 of FIG. 1.

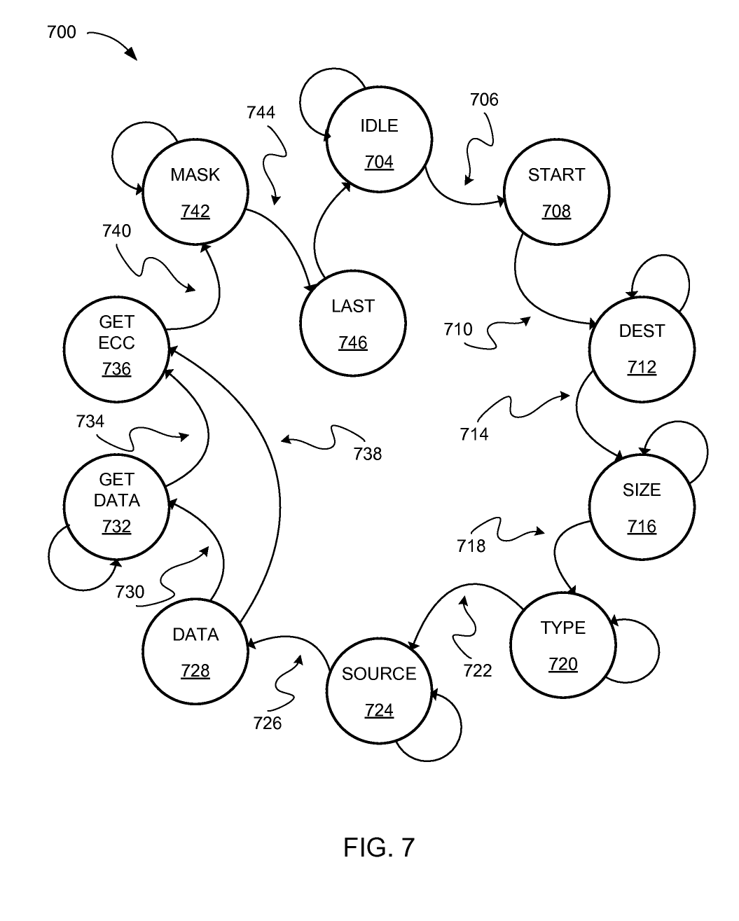

Referring now to FIG. 7, therein is shown examples of state transitions 700 of the electronic system 100 in an embodiment of the invention. The electronic system 100 can provide decode for memory packets including memory network packets, the memory packets 246 of FIG. 2, the packets 300 of FIG. 3, or combination thereof.

In an embodiment, each data field of the packet such as the packet 300 has a specific size or predetermined data quantity. The data quantity can be reached or achieved for one of the data fields resulting in generating end entries for each data field or type. A compare can be performed with a last character of each of the data fields at an end of the packet to determine validity. If the last character at the end of the packet does not represent a destination, the entirety of the packet is considered invalid and marked as invalid.

In an embodiment, a response is sent for each of the packets sent. The response after an idle process 704 can include a buffer sync character, a number of buffer credits, or combination thereof. The buffer credits can include a number of buffers available at a receiving link's end. The buffer credits can be sent based on a current packet routed from the receiving link. Sending or providing a value of zero (0) or a number of buffers matching a number of buffer credits last received can result in stopping transmission, only syncing characters sent, or combination thereof. A new number of the buffer credits, indicating a number of buffers available, can result in resuming or initiating transmission.

For example, a node, such as the first memory node 274 of FIG. 2, the second memory node 278 of FIG. 2, the first cache node 244 of FIG. 2, the second cache node 248 of FIG. 2, or combination thereof, can have a node address of zero (0) based on a node address that has not yet been set. During configuration of node or system addresses, all nodes can respond as node address zero (0), particularly during power on.

Further for example, each of the nodes can query other connected nodes for an address, set an address based on unset addresses on a per-link basis, or combination thereof. Thus, connections between the nodes can be determined including redundant connections for a particular pair of the nodes. The electronic system 100 can determine, configure, or combination thereof, network topology including sources, the nodes, destinations, all connections, or combination thereof.

The state transitions 700 can include the idle process 704 such as an idle state, an idle then start entry 706 such as an idle then start character, or combination thereof. The idle then start entry 706 can result in a start state 708 providing a transmission 710 to a destination process 712. Completing the transmission 710 from the start state 708 with the destination process 712 can result in an end destination entry 714 such as an end destination character. The end destination entry 714 can result in a size process 716. The size process 716 can determine an end size entry 718 provided to a type process 720. The type process 720 can provide an end type entry 722 for a source process 724.

The source process 724 can provide an end source entry 726 for a data process 728 such as a data character process. The data process 728 can provide a data entry 730 such as a data character for a get data process 732. The get data process 732 can provide an end data entry 734 such as an end data character for a get error correction process 736. Alternatively, the data process 728 can provide a non data entry 738 such as a not data character for the get error correction process 736.

The get error correction process 736 can provide an end error correction entry 740 for a mask process 742. The mask process 742, such as a memory access process, can provide an end mask entry 744, such as an end memory access character, for a last entry process 746 such as a last character process. The last entry process 746 can return the electronic system 100 to the idle process 704.

For illustrative purposes the examples of the state transitions 700 of the electronic system 100 are shown with an idle process 704, although it is understood that the idle process 704 may be optional except during power on.

It has been discovered that the electronic system 100 with the examples of the state transitions 700 provides memory transactions with extremely low latency. The extremely low latency results in full performance or maximum performance for the electronic system 100.

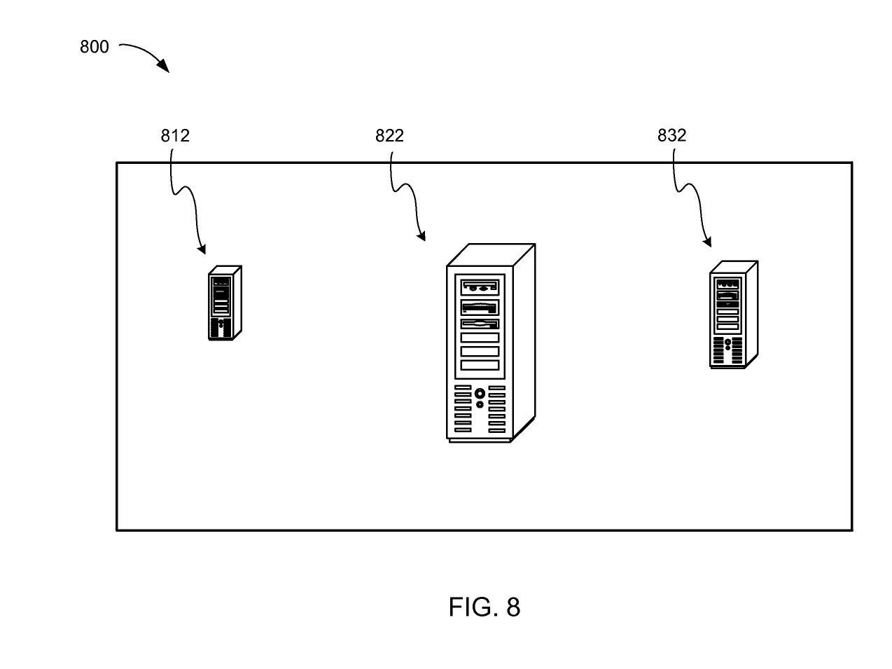

Referring now to FIG. 8, therein is shown examples of embodiments of the electronic system 100. The examples of the embodiments include application examples for the electronic system 100 such as a client computer 812, a server rack 822, a server computer 832, or combination thereof.

These application examples illustrate purposes or functions of various embodiments of the invention and importance of improvements in processing performance including improved bandwidth, area-efficiency, or combination thereof. For example, the first host processor 104, the second host processor 106, the memory device 108, the network 118, or combination thereof, can provide minimal or low latency transfer of the memory request, the memory commands, the memory data, or combination thereof.

In an example where an embodiment of the invention includes the compute sled 204 of FIG. 2, the memory sled 208 of FIG. 2, or combination thereof, the electronic system 100 can provide the low latency protocol 240 of FIG. 2 such as the transaction protocol 140 of FIG. 1, or combination thereof. Various embodiments of the invention provide easy routablility, extremely low latency, high bandwidth, or combination thereof, thereby improving system performance, improving system cost, reducing equipment footprint, reducing power consumption, reducing total ownership cost, or combination thereof.

The electronic system 100, such as the client computer 812, the server rack 822, and the server computer 832, can include one or more of a subsystem (not shown), such as a printed circuit board having various embodiments of the invention, or an electronic assembly (not shown) having various embodiments of the invention. The electronic system 100 can also be implemented as an adapter card in the client computer 812, the server rack 822, and the server computer 832, or combination thereof.

Thus, the client computer 812, the server rack 822, and the server computer 832, other electronic devices, or combination thereof, can provide significantly faster throughput with the electronic system 100 such as processing, output, transmission, storage, communication, display, other electronic functions, or combination thereof. For illustrative purposes, the client computer 812, the server rack 822, and the server computer 832, other electronic devices, or combination thereof, are shown although it is understood that the electronic system 100 can be used in any electronic device.

For illustrative purposes, the electronic system 100 is shown as the client computer 812, the server rack 822, and the server computer 832, other electronic devices, or combination thereof, although it is understood that any device, module, hardware, software, firmware, or combination thereof, may be implemented.

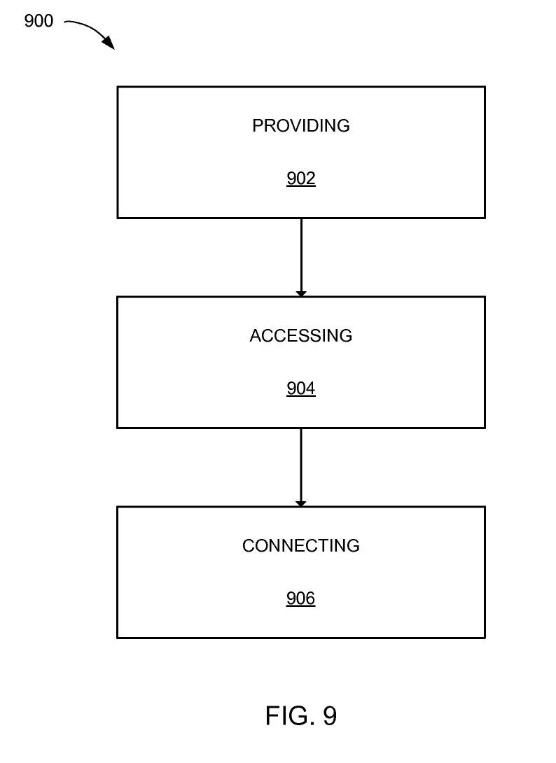

Referring now to FIG. 9, therein is shown a flow chart of a method 900 of operation of an electronic system 100 in an embodiment of the invention. The method 900 includes: providing a network in a block 902; accessing a memory, coupled to the network in a block 904; and connecting a processor, coupled to the network and the memory, for providing a transaction protocol with cut through in a block 906.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the invention is that it valuably supports and services the historical trend of reducing costs, simplifying systems, and increasing performance.

These and other valuable aspects of an embodiment of the invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a network;
a memory device, coupled to the network;
a host processor, coupled to the network and the memory device, providing a transaction protocol including cut through.

2. The system as claimed in claim 1 further comprising a compute route node, coupled to the network, for the transaction protocol.

3. The system as claimed in claim 1 further comprising a memory route node, coupled to the network, for the transaction protocol.

4. The system as claimed in claim 1 wherein the network includes a memory transaction for transfer with the transaction protocol including cut through.

5. The system as claimed in claim 1 wherein the network includes a memory transaction for access on the network.

6. The system as claimed in claim 1 wherein the network includes a packet for transfer with the transaction protocol including cut through.

7. The system as claimed in claim 1 wherein the network includes a packet for access on the network.

8. The system as claimed in claim 1 wherein the network includes a start section for starting the transaction protocol.

9. The system as claimed in claim 1 wherein the network includes an end section for ending the transaction protocol.

10. The system as claimed in claim 1 further comprising a route device, coupled to the network, for providing access to the memory.

11. A method of operation of an electronic system comprising:
providing a network;
accessing a memory, coupled to the network;
connecting a processor, coupled to the network and the memory, for providing a transaction protocol with cut through.

12. The method as claimed in claim 11 further comprising providing a compute route node, coupled to the network, for the transaction protocol.

13. The method as claimed in claim 11 further comprising providing a memory route node, coupled to the network, for the transaction protocol.

14. The method as claimed in claim 11 further comprising providing a memory transaction for transfer with the transaction protocol including cut through.

15. The method as claimed in claim 11 further comprising providing a memory transaction for access on the network.

16. The method as claimed in claim 11 further comprising providing a packet, coupled for transfer with the transaction protocol including cut through.

17. The method as claimed in claim 11 further comprising providing a packet for access on the network.

18. The method as claimed in claim 11 further comprising providing a start section for starting the transaction protocol.

19. The method as claimed in claim 11 further comprising providing an end section for ending the transaction protocol.

20. The method as claimed in claim 11 further comprising providing a route device, coupled to the network, for providing access to the memory.
